(19) United States
(12) Patent Application Publication
(10) Pub. No.: US 2011/0072359 A1
(43) Pub. Date: Mar. 24, 2011

(54) APPARATUS AND METHOD FOR PROVIDING CUSTOMIZABLE REMOTE USER INTERFACE PAGE

(75) Inventors: Young-Wan SO, Gunpo-si (KR); Young-Sun Ryu, Seongnam-si (KR); Jae-Yeon Song, Seoul (KR)

(73) Assignee: Samsung Electronics Co., Ltd., Suwon-si (KR)

(21) Appl. No.: 12/888,077

(22) Filed: Sep. 22, 2010

(30) Foreign Application Priority Data
Sep. 24, 2009 (KR) 10-2009-0090498

(51) Int. Cl. G06F 3/01

(52) U.S. Cl. 715/744

(57) ABSTRACT

An apparatus and method for providing a customizable RUI page. The method includes setting object information including customization capability information and an attribute to an object of a User Interface (UI) to be configured at the RUI page; transmitting the set object information to a UI page-configuring unit to configure the RUI page using the object information; and when request for a user-customized object is received, configuring and transmitting the requested user-customized object according to object information included in the request.

### PRIORITY

This application claims priority under 35 U.S.C. §119(a) to an application filed in the Korean Industrial Property Office on Sep. 24, 2009 and assigned Serial No. 10-2009-0090498, the contents of which are hereby incorporated by reference.

### BACKGROUND OF THE INVENTION

1. Field of the Invention

The present invention relates generally to a Remote User Interface (RUI) system providing a User Interface (UI) to a remote user, and more particularly to a method for providing a customizable RUI page based on an input pattern and preference of a user in an RUI system.

2. Description of the Related Art

Research to improve home network techniques has been actively performed by industry standards associations such as Digital Living Network Alliance (DLNA), Home Audio-Video Interoperability (HAVi), or Universal Plug and Play (UPnP).

In a home network, RUI technology may be used to allow one device to use an RUI technique to control the function of another device. Generally, RUI technology, which is based on a client-server architecture, allows an RUI Client (RUIC) to acquire a UI from an RUI Server (RUIS) so as to allow a user to control the RUIS in the RUI Client through the acquired UI.

FIG. 1 is a diagram illustrating a conventional procedure of transferring and displaying an RUI page and contents provided from an RUIS to an RUIC.

Referring to FIG. 1, the RUI page and contents provided from an RUIS 100 are transferred to an RUIC 101, and the device screen of the RUIC 101 displays the corresponding contents and a UI page 102. That is, the RUIC 101 receives the RUI page, which is unilaterally provided from the RUIS 100, and merely displays the received RUI page on the screen, without making any changes thereto.

However, a size and a shape of each input button of the UI in the RUI page 102 provided from the RUIS 100 are fixed. Additionally, the arrangement of all objects on the screen is unilaterally determined by the RUIS 100. Consequently, the probability of a wrong input increases due to the input pattern being determined based on the physical features of the user and the type of input device actually used by the user, such as key board, touch input, mouse, or keyboard of portable terminal. For example, when a user performs an input operation at an RUI page using a small touch UI of a portable telephone terminal, a wrong input may frequently occur. Furthermore, the pushed position of a specific button may deviate, so as to incur a wrong input, depending on how the user is holding the terminal and physical features of the user, such as a finger's length or thickness.

Additionally, when UI input buttons with low use frequency occupy unnecessary space in an input environment of a portable terminal having a small screen, the probability of a wrong input increases.

As described above, the conventional procedure of merely using an RUI page in an RUIC unilaterally provided from an RUIS can cause a number of problems. Accordingly, a need exists for an improved UI page which meets the input environment and input pattern of the user.

### SUMMARY OF THE INVENTION

Accordingly, the present invention has been made to solve at least the above-mentioned problems occurring in the prior art, and to provide a method for reconfiguring an RUI page rendering, in an RUIC device, to meet an input pattern or environment of a user, and an apparatus thereof.

An aspect of the present invention is to reconfigure and provide an RUI page being rendered in an RUIC device according to an input pattern and taste of a user, thereby reducing the number a wrong inputs, providing a customized RUI meeting a user's taste, and reducing a number of unnecessary UI input buttons.

In accordance with an aspect of the present invention, there is provided a method for generating a customizable Remote User Interface (RUI) page. The method includes setting object information including customization capability information and an attribute to an object of a User Interface (UI) to be configured at the RUI page; transmitting the set object information to a UI page-configuring unit to configure the RUI page using the object information; and once a request for a user-customized object is received, configuring and transmitting the requested user-customized object according to object information included in the request.

In accordance with another aspect of the present invention, there is provided a method for driving a customizable Remote User Interface (RUI) page. The method includes parsing the customizable RUI page received by an RUI Client (RUIC) to identify object information including customization capability information and an attribute with respect to an object included in the customizable RUI page; determining whether to reconfigure the object as a user-customized object or to request the user-customized object based on a user preference or a user input pattern from the RUIC; reconfiguring or requesting the user-customized object according to the determination; and building up the user-customized RUI page by using the reconfigured user-customized object or the received user-customized object from RUIS and delivers the user-customized RUI page to UI Page Display Unit to render the user-customized RUI page.

In accordance with another aspect of the present invention, there is provided an apparatus for generating a customizable Remote User Interface (RUI) page. The apparatus includes a customizable object and attribute-setting unit for setting object information including customization capability information and an attribute to an object of a User Interface (UI) to be configured at the RUI page, and transmitting the set object information to a UI page-configuring unit to configure the RUI page using the object information; and a customized object-generating unit receiving a request for user-customized object, and configuring and transmitting the requested user-customized object according to object information included in the request.

In accordance with another aspect of the present invention, there is provided an apparatus for driving a customizable Remote User Interface (RUI) page. The apparatus includes a User Interface (UI) input pattern information storage unit storing user UI input pattern information and user preference information through an RUI Client (RUIC); a customized RUI page-configuring unit parsing the customizable RUI page received by the RUIC to identify object information including customization capability information and an attribute with respect to an object included in the customizable RUI page, determining whether to configure a user-customized RUI page by itself or to request the user-customized object based on the user input pattern information and the user preference information stored in the UI input pattern information storage unit and configuring the user-customized RUI page according to the determination and delivering the reconfigured user-customized RUI page to UI Page Display Unit; and a customized object-requesting unit requesting the user-customized object according to the determination of the customized RUI page-configuring unit.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a conventional procedure of transferring and displaying an RUI page and contents provided from an RUIS to an RUIC;

FIG. 2 is a diagram illustrating a procedure of customizing an RUI page provided to an RUIC device from an RUIS to meet an input pattern of an RUIC user according to an embodiment of the present invention;

FIG. 3 is a flow chart illustrating an operation of a generator according to an embodiment of the present invention;

FIG. 4 is a flow chart illustrating an operation of a driver according to an embodiment of the present invention;

FIG. 5 is a block diagram illustrating a generator according to an embodiment of the present invention;

FIG. 6 is a block diagram illustrating a driver according to an embodiment of the present invention;

FIG. 7 is a signaling diagram illustrating an operation for generating a customized UI page, where all structural elements of the generator and the driver are included in the RUIC, except for a customizable object and attribute-setting unit of the generator, according to an embodiment of the present invention;

FIG. 8 is a signaling diagram illustrating an operation for generating a customized UI page, where all structural elements of the generator and the driver are included in an RUIS, except for a partial function of a customized RUI page-configuring unit, according to an embodiment of the present invention;

FIG. 9 is a signaling diagram illustrating an operation of executing functions of a generator and a driver by an RUIS and an RUIC, respectively according to an embodiment of the present invention; and

FIG. 10 illustrates a Cascading Style Sheet (CSS) for generating a customizable RUI page according to an embodiment of the present invention.

### DETAILED DESCRIPTION OF EMBODIMENTS OF THE INVENTION

Hereinafter, various embodiments of the present invention will be described with reference to the accompanying drawings. In the following description, the same elements will be designated by the same reference numerals although they are shown in different drawings. Further, various specific definitions found in the following description are provided only to help general understanding of the present invention, and it will be apparent to those skilled in the art that the present invention can be implemented without such definitions. Further, in the following description of the present invention, a detailed description of known functions and configurations incorporated herein will be omitted when it may make the subject matter of the present invention rather unclear.

In accordance with an embodiment of the present invention, a generator is provided for generating a customizable RUI page, and a driver is provided for receiving a customized RUI object, which is customized to meet a user's desire, and reconstructing and providing to the user a corresponding UI page which meets the user's use pattern. Here, the generator and the driver can be a logic entity that are additionally used to provide a customizable service in an RUI system, which can be physically included in one device or each of an RUIS and an RUIC, respectively.

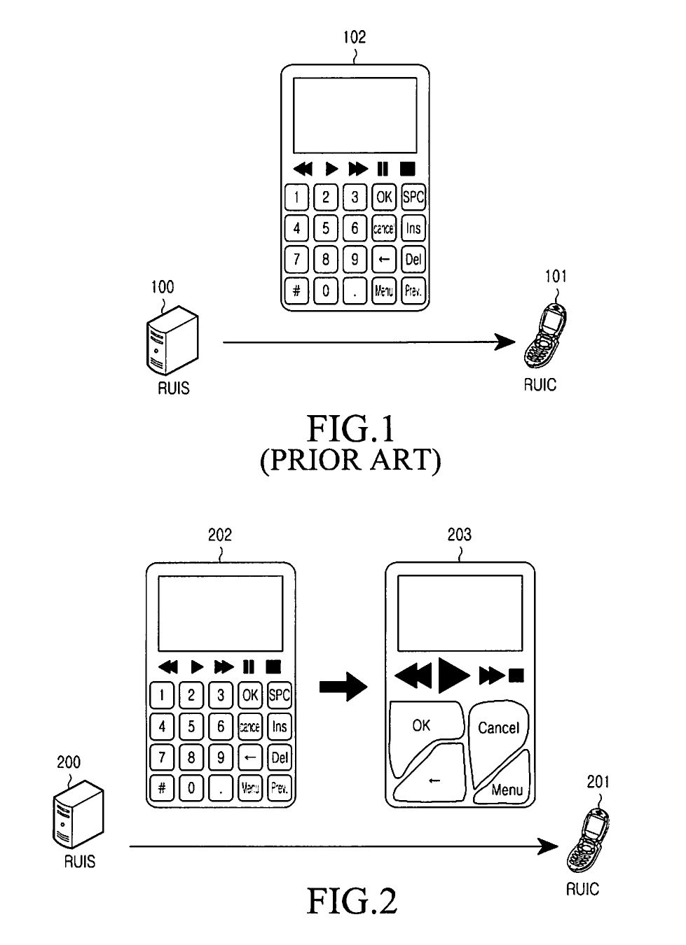

FIG. 2 is a diagram illustrating a procedure of customizing an RUI page provided to an RUIC device from an RUIS to meet an input pattern of an RUIC user according to an embodiment of the present invention.

Referring to FIG. 2, the RUIS 200 remotely transmits an RUI to the RUIC 201, and renders the transmitted RUI and contents on a screen of the RUIC 201. According to a preference of a user that is using the contents in the RUIC 201 or stored input pattern information of a user, attributes may be allotted to objects included in the RUI to configure a user-customized RUI page. For example, a ‘Hidden’ attribute can be allotted to an unnecessary UI button, which is not frequently used by a user, thereby removing the unnecessary UI button, and instead this space may be allotted to a button that is used more frequently. A button that is frequently selected by the user may be positioned at a central portion of a screen, and the size and shape of the button may be changed to be easily used, thereby reducing the chances for a wrong input.

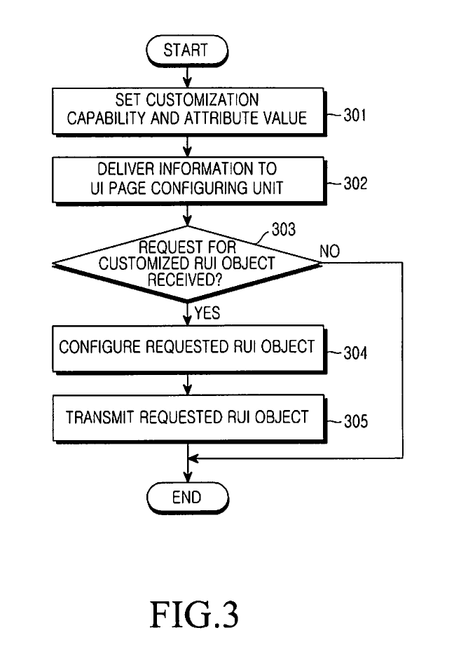

FIG. 3 is a flow chart illustrating an operation of a generator according to an embodiment of the present invention.

As described above, locations of the generator and the driver can change according to their implementation. That is, the RUIS 200 and the RUIC 201 may perform functions of the generator and the driver, respectively, the RUIC 201 may perform both a function of the generator and a function of the driver, or partial structural devices of the generator and the driver may be suitably distributed to the RUIS 200 and the RUIC 201.

Referring to FIG. 3, in step 301, a generator determines if each UI object to be configured in an RUI page can be provided as a user-customizable type, and defines attribute values of respective objects or addresses capable of requesting corresponding UI objects, when the respective UI objects can be provided. Specifically, in order to provide objects as user-customizable types, the respective UI objects are divided into UI objects to be corrected or changed, and UI objects not to be corrected or changed. Further, when there is an object to be provided as a customizable type, the generator defines a range or a level of an attribute value such as size, position, and shape of a corresponding object, and information with respect to RUI objects, such as a URL address that is capable of requesting a corresponding object.

In step 302, the generator delivers the information with respect to the RUI objects to a UI page-configuring unit of an RUIS 200 to be reflected upon configuring an RUI page to be sent to the RUIC 201.

In step 303, the generator determines if a request for a customized RUI object is received from the driver for a transmitted RUI page. When the request for a customized RUI object is received, the generator newly configures the requested RUI object according to information with respect to RUI objects in step 304, and transmits the configured RUI object in step 305.

When the request for a customized RUI object is not received, the generator terminates all operations.

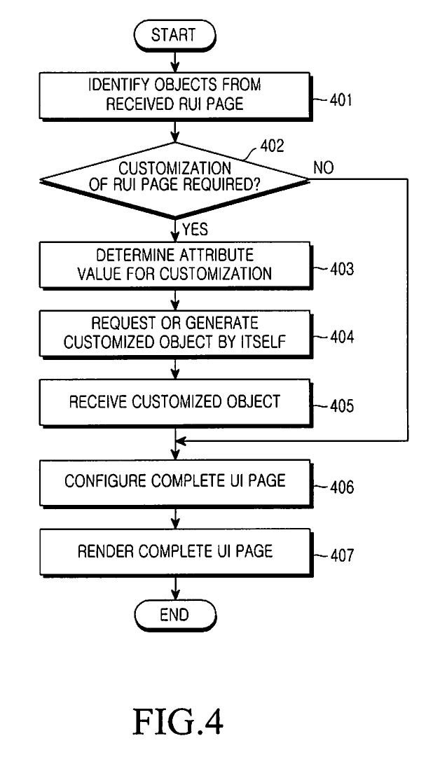

FIG. 4 is a flow chart illustrating an operation of a driver according to an embodiment of the present invention.

Referring to FIG. 4, in step 401, the driver parses the RUI page received by a UI page-receiving unit of an RUIC from the RUIS, and identifies the presence of objects configuring an RUI page, customization capability information, attribute values, and request addresses, etc.

In step 402, the driver determines whether to reconfigure an RUI page to a user-customized page based on a user preference or stored user input pattern. For example, the driver designates a UI button with low use frequency according to a user preference. The driver determines whether to request inactivation of the designated UI button or to reconstruct it based on a user's input pattern characteristic, which is accumulated and stored for about a specific UI object, when it satisfies predefined conditions determined by an algorithm installed in the driver. The determining procedure can be achieved according to various algorithms or a user preference.

When customization of the RUI page is to be performed, in step 403, the driver determines a UI object ID to be reconfigured to a customizable type and an attribute value of the UI object, based on stored Data Base (DB) information of a user input pattern or user preference DB information.

In step 404, when the driver can generate a corresponding UI object by itself, it generates the corresponding UI object by correcting or changing the corresponding UI object itself, or allotting a new attribute value thereto. Conversely, when the driver cannot generate a corresponding UI object by itself, it requests a corresponding UI object from the generator.

After generating a customized UI object or upon receiving a customized UI object from the generator in step 405, the driver applies the customized UI object to an original customizable RUI page received from the RUIS to configure a customized RUI page optimized to the user at step 406, and transfers the optimized and customized RUI page to a display in order to render the optimized and customized RUI page for a user in step 407.

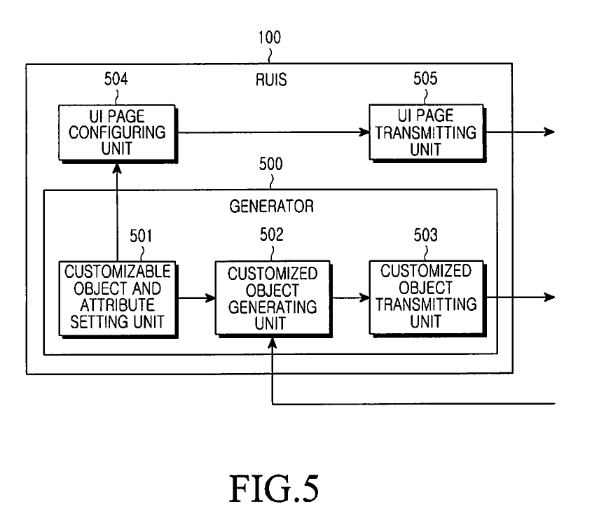

FIG. 5 is a block diagram illustrating an RUIS including a generator according to an embodiment of the present invention.

Referring to FIG. 5, the RUIS 100 includes a UI page-configuring unit 504 for configuring an RUI page to be transferred to an RUIC (not shown), a UI page-transmitting unit 505 for transmitting the configured UI page to the RUIC, and a generator 500. The generator 500 provides information and UI objects for configuring a customized UI page according to an embodiment of the present invention.

The generator 500 includes a customizable object and attribute-setting unit 501, a customized object generating unit 502, and a customizable object-transmitting unit 503. The customizable object and attribute-setting unit 501 determines if specific objects are provided as a user-customizable type or not. When the objects are provided as the user-customizable type, the customizable object and attribute-setting unit 501 generates a default attribute value, such as position and size of an object, a range of an attribute value to be provided, a level of the attribute value, and URL address information that will be used for requesting corresponding customized object, and transfers them to the UI page-configuring unit 504 of the RUIS 100 to be reflected in a configuration of the RUI page.

The customized object generating unit 502 receives a request for a customized UI object provided from the driver, and accordingly reconfigures and transfers the corresponding UI objects as a customizable type to the customized object-transmitting unit 503. Thereafter, the customized object-transmitting unit 503 transmits the requested customized UI object to the driver.

FIG. 5 illustrates the generator that is located at an RUIS, according to an embodiment of the present invention. However, as described above, because the generator and the driver may be included in one device, the customized object-transmitting unit 503 does not always transmit a customized UI object to another device. It is appreciated that the customized UI object can be transferred from a logic entity of the generator to a logic entity of the driver.

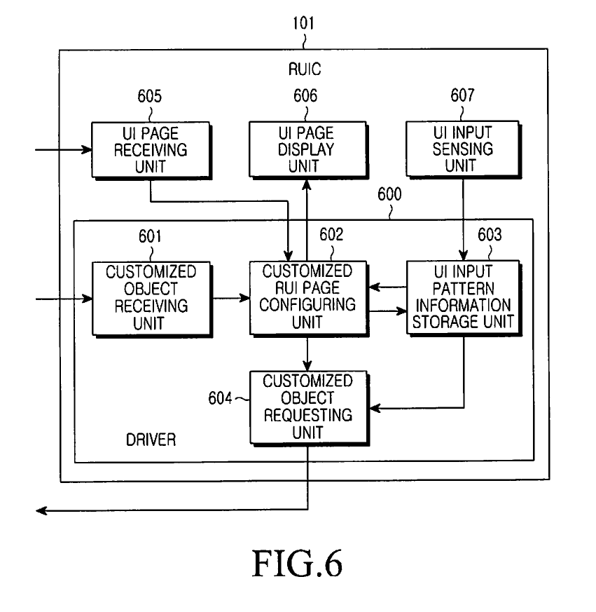

FIG. 6 is a block diagram illustrating an RUIC including a driver according to an embodiment of the present invention.

Referring to FIG. 6, the RUIC 101 includes a UI page-receiving unit 605 for receiving an RUI page provided from an RUIS (not shown), a UI page display unit 606 for rendering a UI page for a user, a UI input-sensing unit 607 for sensing a user input, and a driver 600. The driver 600 configures a customizable UI page to be customized to a user.

Referring to FIG. 6, a customized object-receiving unit 601 receives a customized UI object from a generator, and transfers the received customized UI object to the customized RUI page-configuring unit 602.

The customized RUI page-configuring unit 602 identifies IDs and attribute values of respective UI objects from a customizable RUI page to determine if there is a customizable UI object. When there is a customizable UI object, the customized RUI page-configuring unit 602 determines if customization is required, namely, to request a customized UI based on a stored user input pattern DB or a user preference DB. Further, the customized RUI page-configuring unit 602 applies customized UI objects received from the generator to an original RUI page to be customized and transfers a complete customized RUI page to a UI page display unit 606.

When the customized RUI page-configuring unit 602 determines to request a customized UI from the generator, a request is transferred to a customized object-requesting unit 604 and then transferred to a customized object-generating unit 502 of the generator 500. Moreover, a UI input pattern information storage unit 603 stores a user input pattern about a UI object and user preference information into database.

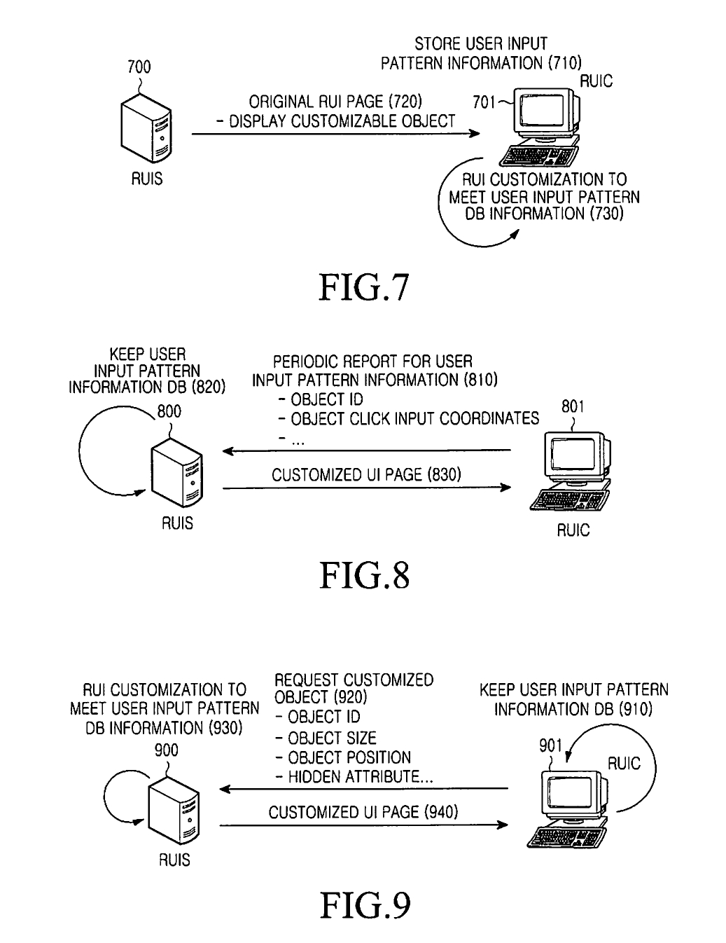

FIG. 7, FIG. 8, and FIG. 9 illustrate signaling between an RUIS and an RUIC, with different positions of the generator and the driver, in a method for configuring a customized UI page according to different embodiments of the present invention.

FIG. 7 illustrates signaling diagram illustrating an operation for generating a customized UI page, where all structural elements of the generator and the driver are included in the RUIC 701, except for a customizable object and attribute-setting unit of the generator.

Referring to FIG. 7, a user input pattern or preference is stored at a DB in an RUIC 701 (710). A customizable RUI page with information set by a customizable object and attribute-setting unit 501 of a generator included in the 30 RUIS 700 is transferred to a UI page receiving unit 605 of the RUIC 701 through a UI page-transmitting unit 505 of the RUIS 700 (720). The driver identifies a type of a customizable UI object from information included in the customizable RUI page received by the UI page receiving unit 605 of the RUIC 701, and generates a customized UI object in order to display a complete customized RUI 35 page on the RUIC 701 (730).

FIG. 8 is illustrates signaling diagram illustrating an operation for generating a customized UI page, where all structural elements of the generator and the driver are included in an RUIS 800, except for a partial function of a customized RUI page-configuring unit.

Referring to FIG. 8, user input pattern information or preference with respect to a UI object is reported to an RUIS 800 from an RUIC 801, periodically or at a determined time (810), and is stored in a UI input pattern information storage unit of a driver provided at the RUIS 800 (820). The stored information is used to provide a customized RUI page (830). The information reported to the RUIS 800 from the RUIC 801 may include IDs of UI objects used by a user, use frequency of corresponding objects, user input coordinates information (click position on button) with respect to corresponding objects, and pattern information such as click position information on a full screen.

FIG. 9 is a signaling diagram illustrating an operation of executing functions of a generator and a driver by an RUIS 900 and an RUIC 901, respectively.

Referring to FIG. 9, user input pattern information and preference information are made into a DB to be stored in a UI input pattern information storage unit of a driver included in the RUIC 901 (910). Based on the user input pattern and preference information, a customized RUI page-configuring unit of a driver included in the RUIC 901 selects customizable objects among plural objects of the received RUI page, and specifies and requests information regarding a corresponding object of any shape, size, and position to be provided from a generator of the RUIS 900 (920). A customized object-generating unit of a generator included in the RUIS 900 generates UI objects according to a request from the driver (930) and transfers it to a customized object-receiving unit of the driver included in the RUIC 901 through a customized object-transmitting unit (940). A customized RUI page-configuring unit of the driver included in the RUIC 901 configures a user-customized RUI page using the customized UI objects and renders it on a UI page display unit of the RUIC 901.

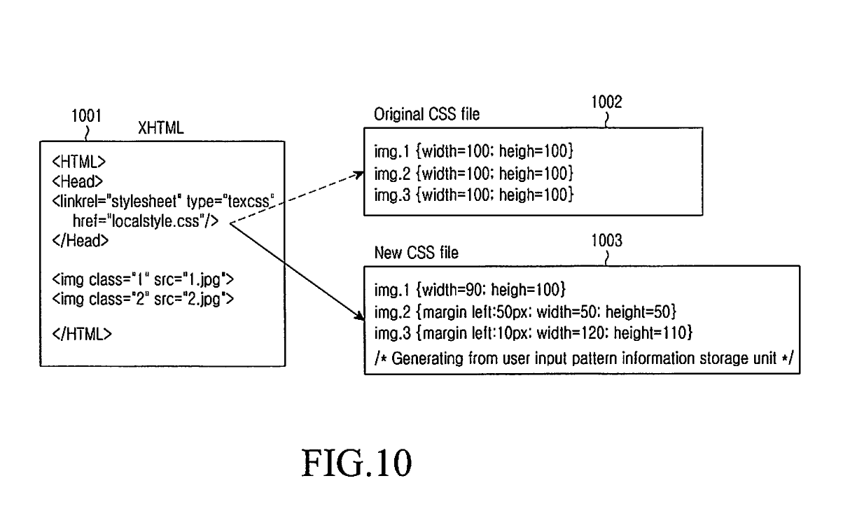

FIG. 10 illustrates a CSS for constructing a customizable RUI page according to an embodiment of the present invention.

Referring to FIG. 10, at first a customizable RUI page 1001 is shown to a user in such a way that a style of the customized RUI page 1001 is rendered with default attribute values defined in an original CSS file 1002. However, when an attribute value such as a position and/or a size of a specific UI object is requested to be changed by a RUIC, a new CSS file 1003 to which a changed attribute value is applied in place of the original CSS file 1002, to provide a customized RUI page to the user.

While the present invention has been shown and described with reference to certain embodiments thereof, it will be understood by those skilled in the art that various changes in form and details may be made therein without departing from the spirit and scope of the invention as defined by the appended claims and any equivalents thereof.

What is claimed is:

1. A method for generating a customizable Remote User Interface (RUI) page, comprising the steps of:
setting object information, which includes an attribute and customization capability information, to an object of a User Interface (UI) to be configured in the RUI page;
transmitting the set object information to a UI page-configuring unit to configure the RUI page using the object information; and
when a request for a user-customized object is received, configuring and transmitting the requested user-customized object according to object information included in the request.

2. The method of claim 1, wherein the object information includes an address capable of requesting the object.

3. The method of claim 1, wherein the customization capability information includes information indicating if an object can be customized.

4. A method for driving a customizable Remote User Interface (RUI) page, comprising the steps of:
parsing the customizable RUI page received by an RUI Client (RUIC) to identify object information, which includes an attribute and customization capability information, with respect to an object included in the customizable RUI page;
determining whether to reconfigure the object as a user-customized object or to request the user-customized object based on a user preference or a user input pattern from the RUIC;
reconfiguring or requesting the user-customized object according to the determination; and
configuring and rendering the customized RUI page using the reconfigured user-customized object or the user-customized object received by the request.

5. The method of claim 4, wherein the object information includes an address capable of requesting the user-customized object.

6. The method of claim 4, wherein the customization capability information includes information indicating whether the object can be customized.

7. The method of claim 4, wherein reconfiguring or requesting the user-customized object according to the determination comprises inactivating an object with a use frequency smaller than a predetermined value according to the user preference.

8. The method of claim 4, wherein configuring the user-customized RUI page or requesting the user-customized object according to the determination comprises configuring the user-customized RUI page when a user input pattern characteristic for the object satisfies a predetermined condition.

9. The method of claim 4, further comprising requesting an attribute value of the requested user-customized object.

10. An apparatus for generating a customizable Remote User Interface (RUI) page, comprising:
a customizable object and attribute-setting unit for setting object information including customization capability information and an attribute to an object of a user interface (UI) to be configured at the RUI page, and transmitting the set object information to a UI page-configuring unit to configure the RUI page using the object information; and
a customized object-generating unit receiving a request for user-customized object, and configuring and transmitting the requested user-customized object according to object information included in the request.

11. The apparatus of claim 10, wherein the object information includes an address capable of requesting the object.

12. The apparatus of claim 10, wherein the customization capability information indicates if the object can be customized.

13. The apparatus of claim 10, further comprising a customized object-transmitting unit transmitting the user-customized object generated by the customized object-generating unit.

14. An apparatus for driving a customizable Remote User Interface (RUI) page, comprising:
a User Interface (UI) input pattern information storage unit storing user UI input pattern information and user preference information through an RUI Client (RUIC);
a customized RUI page-configuring unit for parsing the customizable RUI page received by the RUIC to identify object information including customization capability information and an attribute with respect to an object included in the customizable RUI page, determining whether to configure a user-customized RUI page using the object by itself or to request the user-customized object based on the user input pattern information and the user preference information stored in the UI input pattern information storage unit, configuring the user-customized RUI page according to the determination, and delivering customized RUI page to UI Page Display Unit for rendering ; and
a customized object-requesting unit for requesting the user-customized object according to the determination of the customizable RUI page-configuring unit.

15. The apparatus of claim 14, wherein the object information includes an address capable of requesting the user-customized object.

16. The apparatus of claim 14, wherein the customization capability information indicates whether the object can be customized.

17. The apparatus of claim 14, wherein the customized RUI page-configuring unit determines an object with a use frequency lower than a predetermined value according to the user preference.

18. The method of claim 14, wherein the customized RUI page-configuring unit determines whether to configure the user-customized RUI page by itself or request user-customized object to an RUI Server (RUIS), when a user input pattern characteristic with the object satisfies predetermined conditions.

19. The method of claim 14, wherein the customized object-requesting unit requests an attribute value of the requested user-customized object.

20. The apparatus of claim 14, further comprising a customized object-receiving unit for receiving and transmitting a user-customized object to the customized RUI page-configuring unit.
